(19) United States
(12) Patent Application Publication
(10) Pub. No.: US 2016/0196703 A1
(43) Pub. Date: Jul. 7, 2016

(54) SMART DOOR SYSTEM AND IDENTIFICATION SYSTEM BACKGROUND

(71) Applicant: VIA TECHNOLOGIES, INC., New Taipei City (TW)

(72) Inventor: Jui-Cheng JEAN, New Taipei City (TW)

(21) Appl. No.: 15/000,205

(22) Filed: Jan. 19, 2016

Related U.S. Application Data
(60) Provisional application No. 62/272,112, filed on Dec. 29, 2015.

(30) Foreign Application Priority Data
Jan. 19, 2016 (TW) 105200759

(51) Int. Cl. G07C 9/00; G06K 9/00; H04N 7/18

(52) U.S. Cl. CPC G07C 9/00158; G07C 9/00309; H04N 7/186; G06K 9/00288

(57) ABSTRACT

The content provides a smart door system and identification system. The identification system includes a Bluetooth low energy (BLE) signal broadcasting apparatus, a signal processing apparatus, a wireless signal receiving apparatus and a server. The signal processing apparatus receives a BLE signal broadcasted by the BLE signal broadcasting apparatus and transmits identification information to the wireless signal receiving apparatus by wireless communication. The server stores verification information and determines what the signal processing apparatus represents in accordance with a relationship between the verification information and the identification information received from the wireless signal receiving apparatus.

### CROSS REFERENCE TO RELATED APPLICATIONS

This application claims priority under 35 U.S.C. 119(e) to U.S. Provisional Application No. 62/272,112, filed on Dec. 29, 2015. This application also claims priority of Taiwan Patent Application No. 105200759, filed on Jan 19, 2016, the entirety of which is incorporated by reference herein.

### BACKGROUND

1. Field of the Invention

The present disclosure relates to a wireless application, and more particularly to a smart door system and an identification system using wireless signal.

2. Description of the Related Art

As technology advances, the portal security has gradually changed from the use of manual locks into intelligent and automated devices. Further, in order to facilitate residences of townhouse or specific groups, such as residences of condominium, travelers of a hostel, or employees of a company, to manage the personnel access and to keep their safety, it is very important and there is an urgent need for the development of an appropriate door lock system and identification system.

### SUMMARY

In order to address the above-mentioned problems, the disclosure provides a smart door system and an identification system to easily facilitate multi-person access control management.

In one embodiment, the disclosure provides a door lock system. The door lock system is adapted to be used in a door including a door panel and a door frame. The door lock system includes a lock unit, an electric charging unit, and a lock control unit. The lock unit is disposed in the door panel or the door frame. The lock unit includes an electrical lock disengaging and engaging driving apparatus. The lock unit is connected to the lock control unit by wired or wireless means. The electric charging unit includes a power supply apparatus and a power storage apparatus. The power supply apparatus comprises two separated devices installed on door panel and door frame respectively and enable the power storage apparatus to access external electric power. The power storage apparatus is disposed on the door panel and is used to store and supply electric power to the lock unit and the lock control unit. The lock control unit includes a housing, a resonance speaker, a key apparatus, a storage device, an optical sensing apparatus, and an identification process apparatus. The housing is fixed on the door panel or the door frame, and a space is defined in the inner side of the housing. The resonance speaker is disposed in the space or is independently disposed outside with a connecting wire line. The resonance speaker receives the electrical signal from identification process apparatus. A sympathetic vibration occurs in a first region of the housing as the resonance speaker producing vibration or as a contact between the resonance speaker and the door panel or the door frame, so as to generate voice or alarm sound directed by the identification process apparatus. The key apparatus is disposed at a second region of the housing. The key apparatus provides a number of the keys and generates key information in response to the order in which the keys are pressed. The storage apparatus stores one or more of verification information. The optical sensing apparatus is electrically coupled to the identification process apparatus and detects the exterior moving object near the door and generates pre-set signal to switch on the identification process apparatus as objects coming approach to the door. The identification process apparatus includes a central process apparatus. The central process apparatus is electrically coupled to the storage apparatus and the key apparatus. By analyzing the key information received from key apparatus and comparing to the verification information stored in the storage apparatus, the central process apparatus determine to send lock or unlock signal to the lock unit or send an alarm sound signal to resonance speaker.

In another embodiment, the disclosure provides a smart door lock system. The smart door lock system is adapted to be used in a door including a door panel and a door frame. The smart door lock system includes a mobile apparatus APP, a lock unit, an electric charging unit, and a lock control unit. The lock unit is disposed in the door panel or the door frame. The lock unit includes an electrical lock disengaging and engaging driving apparatus and an electrical lock position sensing apparatus. The lock unit is connected to the lock control unit by wired or wireless means. The electric charging unit includes a power supply apparatus and a power storage apparatus. The power supply apparatus comprises two separated devices installed on door panel and door frame respectively and enable the power storage apparatus to access external electric power. The power storage apparatus is disposed on the door panel and is used to store and supply electric power to the lock unit and the lock control unit. The lock control unit includes a housing, a resonance speaker, a key apparatus, a storage device, an optical sensing apparatus, and an identification process apparatus. The housing is fixed on the door panel or the door frame, and a space is defined in the inner side of the housing. The resonance speaker is disposed in the space or is independently disposed outside with a connecting wire line. The resonance speaker receives the electrical signal from identification process apparatus. A sympathetic vibration occurs in a first region of the housing as the resonance speaker producing vibration or as a contact between the resonance speaker and the door panel or the door frame, so as to generate voice or alarm sound directed by the identification process apparatus. The key apparatus is disposed at a second region of the housing. The key apparatus provides a number of the keys and generates key information in response to the order in which the keys are pressed. The storage apparatus stores one or more of verification information. The optical sensing apparatus is electrically coupled to the identification process apparatus and detects the exterior moving object near the door and generates pre-set signal to switch on the identification process apparatus as objects coming approach to the door. The identification process apparatus includes a BLE signal broadcasting apparatus, a wireless signal transceiver apparatus, and a central process apparatus. The central process apparatus is electrically coupled to the storage apparatus and the key apparatus and the wireless signal transceiver apparatus. When the mobile apparatus APP receive the BLE signal from the BLE signal broadcasting apparatus, the mobile apparatus APP transmits the corresponding identification information by wireless means to the wireless signal transceiver apparatus. By analyzing the identification information received by the wireless signal transceiver apparatus and comparing to the verification information stored in the storage apparatus, the central process apparatus determine the privilege of the mobile apparatus APP according to the relationship between the identification information and the verification information. If the privilege is granted according to the verification information, the central process apparatus will send an indication signal through the wireless transceiver to the mobile apparatus APP. Additionally, with the received key information from the key apparatus, an operation to unlock the lock unit or issue an alarm is taken according to the determined privilege.

In another embodiment, the disclosure provides a smart door system including a door, a mobile apparatus APP, a doorbell system, a lock unit, a communication switching system, and an electric charging unit. The electric charging unit includes a power supply apparatus and power storage apparatus. The power supply apparatus comprises two separated devices installed on door panel and door frame respectively and enable the power storage apparatus to access external electric power. The power storage apparatus is positioned on the door panel. The power storage apparatus is used to store and supply electric power to the doorbell system and door lock system. The communication switching system may be placed outside the doorbell system or placed in the doorbell system. The communication switching system utilizes SIP (Session Initiation Protocol) and XMPP (Extensible Messaging and Presence Protocol) as the signaling and communication of the mobile apparatus APP and the doorbell system. The lock unit includes an electricacommunication switching system lock disengaging and engaging driving apparatus and an electrical lock position sensing apparatus. The lock unit is connected to the doorbell system by wired or wireless means. The doorbell system is adapted for using on the door panel or on the door frame or on the external wall. The doorbell system includes a housing, a resonance speaker, a key apparatus, a storage apparatus, an optical sensing apparatus, an optical camera apparatus, and a microphone, an identification process apparatus. The housing is fixed at the door panel or at the door frame, or at the exterior wall next to the door, and a spaced is defined in an inner side of the housing. The resonance speaker receives the electrical signal from identification process apparatus. A sympathetic vibration occurs in a first region of the housing as the resonance speaker producing vibration or as a contact between the resonance speaker and the door panel or the door frame, so as to generate voice or alarm sound directed by the identification process apparatus. The identification process apparatus is electrically coupled to the resonance speaker, the key apparatus, the storage apparatus, the optical sensing apparatus, the optical camera apparatus, and the microphone. The optical sensing apparatus detects exterior moving objects near the doorbell system and generates pre-set signal to switch on the identification process apparatus and the optical camera apparatus as the objects coming approach to doorbell system. The optical camera apparatus produces images outside the door and store the images in the storage apparatus in a picture or video format via the identification process apparatus; the key apparatus positioned in a second region of the housing and provides a number of keys and generates key information in response to the order in which the keys are pressed. One of the keys is a doorbell key. When the doorbell key is pressed or touched, the optical camera apparatus captures the image and record sound outside the door and wirelessly transmits the images and sound to the mobile apparatus APP via the identification process apparatus and the communication switching system, so as to facilitate the intercom function and watch video outside the door simultaneously; the storage apparatus store one or more verification information and the picture or video the optical camera apparatus produced; the identification process apparatus includes a BLE signal broadcasting apparatus, a wireless signal transceiver apparatus, and a central process apparatus. The central process apparatus is electrically coupled to the storage apparatus and the key apparatus and the wireless signal transceiver apparatus. When the mobile apparatus APP receive the BLE signal from the BLE signal broadcasting apparatus, the mobile apparatus APP transmits the corresponding identification information by wireless means to the wireless signal transceiver apparatus. By analyzing the identification information received by the wireless signal transceiver apparatus and comparing to the verification information stored in the storage apparatus, the central process apparatus determine the privilege of the mobile apparatus APP according to the relationship between the identification information and the verification information. If the privilege is granted according to the verification information, the central process apparatus will send an indication signal through the wireless transceiver to the mobile apparatus APP. Additionally, with the received key information from the key apparatus, an operation to unlock the lock unit or issue an alarm is taken according to the determined privilege. Moreover, the optical camera apparatus is able to read picture code and sent the picture code to the identification process apparatus for decoding an identification, and a matching between the verification information stored in the storage apparatus is performed and an operation to unlock the lock unit is determined according to the relationship between the identification information and the verification information.

In another embodiment, the disclosure provides an identification system. The identification system includes a BLE signal broadcasting apparatus, a signal processing apparatus, a wireless signal receiving apparatus, and a server. The signal processing apparatus receives BLE signal broadcasted from the BLE signal broadcasting apparatus via wireless means and transmits the corresponding identification information to the wireless signal receiving apparatus. The server stores verification information and the receives identification information from the wireless signal receiving apparatus, so as to identify the identification of that the signal processing apparatus represents according to the relation of the identification information and the verification information.

In still another embodiment, the disclosure also provides an identification system. The identification system includes a sonic wave transmission apparatus, a sonic wave receiving apparatus, and a server. The sonic wave transmission apparatus generates sonic wave signal and transmits identification information via the sonic wave signal. The sonic wave receiving apparatus receives the sonic wave signal and acquired the identification information. The server is used to store the verification information and is electrical coupled to the sonic wave receiving apparatus so as to recess the identification information from the sonic wave receiving apparatus. The server identifies the identification represented by the sonic wave transmission apparatus in accordance with a relationship between the identification information and the verification information. The identification information includes user number and the current time of the sonic wave transmission apparatus.

With the above-mentioned smart door system or the identification system, the user can effectively facilitate multi-person access control management or identity determination.

### BRIEF DESCRIPTION OF THE DRAWINGS

For a more complete understanding of the embodiments and the advantages thereof, reference is now made to the following descriptions taken in conjunction with the accompanying drawings.

FIG. 1 shows a structural schematic view of a door lock system, in accordance with the first embodiment of the disclosure.

FIG. 2 shows a structural schematic view of another smart door lock system, in accordance with the second embodiment of the disclosure.

FIG. 3A shows a structural schematic view of another smart door system, in accordance with the third embodiment of the disclosure.

FIG. 3B shows a schematic view of a smart door system, in accordance with the third embodiment of the disclosure.

FIG. 4A shows a schematic view of an electric charging unit, in accordance with the first and second embodiment of the disclosure.

FIG. 4B shows a schematic view of another electric charging unit, in accordance with the first and second embodiment of the disclosure.

FIG. 5 shows a schematic view of a door lock system disposed on a door, in accordance with the second embodiment of the disclosure.

FIG. 6 shows a circuit block diagram of an identification system, in accordance with a fourth embodiment of the disclosure.

FIG. 7 shows a circuit block diagram of an identification system, in accordance with the fifth embodiment of the disclosure.

### DESCRIPTION OF THE ILLUSTRATIVE EMBODIMENTS

In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments.

### First Embodiment

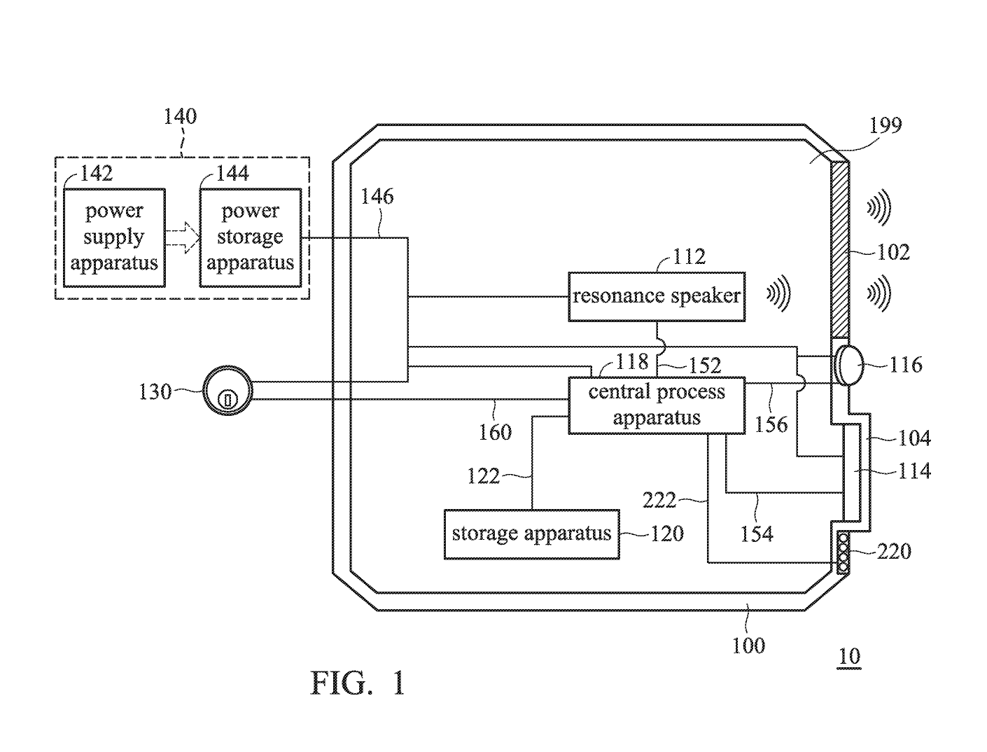

FIG. 1 shows a structural schematic view of a door lock system, in accordance with a first embodiment of the disclosure. In the embodiment, the door lock system 10 includes a lock unit 130, an electric charging unit 140, and a lock control unit. The lock control unit includes a housing 100, a resonance speaker 112, a touch key apparatus 114, an optical sensing apparatus 116, a process apparatus 118, and a storage apparatus 120. A space 199 is formed in the inner side of the housing 100, and a partial element of the lock control unit is placed in the space 199. The lock unit 130 is disposed in the door panel or a door frame of a door.

In order to make the housing 100 have a better waterproof and dust-proof function, the housing 100 is a structure which is made as sealed as possible. In this case, the resonance speaker 112 is disposed in a position in the space 199 that corresponds to a first region 102 of the housing 100, and a sympathetic vibration occurs in the housing 100 and region 102 as the resonance speaker 112 producing vibration (e.g., as the resonance speaker 112 is controlled by the process apparatus 118 via the signal line 152), thereby the sound generate by the resonance speaker 112 is sent out. Additionally, the touch key apparatus 114 is embedded in the second region 104 of the housing 100, and, as shown in the figure, the second region 104 of the housing 100 is used as a key region of the key apparatus 114 where the user controls the key apparatus 114 by pressing the second region 104. Moreover, with suitable water-proof and dust-proof design between the optical sensing apparatus 116 and the housing 100, the housing 100 may have a water-proof and dust-proof function, and the door lock system 10 is able to concur against adverse factors in surroundings.

In the embodiment, the key apparatus 114 should provide two or more keys (not shown). After the user presses at least one key, the touch key apparatus 114 generates key information in response to the order in which the keys are pressed and transmits the key information to the central process apparatus 118 via the signal line 154. The central process apparatus accesses verification information that stored in the storage apparatus 120 by signal line 122. In the operation of the door lock system 10, optical sensing apparatus 220 detect a moving object and signal to switch on the central process apparatus 118 and key apparatus 114. By analyzing the key information and the verification information, the lock member 130 is determined to be locked or unlocked according to the key information and the verification information.

For example, the verification information may be a set of password for opening the door. When the key information is as the same as the verification information, the process apparatus 118 immediately transmits signal to the lock member 130 via the signal line 130 to unlock the lock member 130. If the key information is different from the verification information and meets a specific ordered, the central process apparatus 118 the lock member 130 will not be unlocked by the central process apparatus 118, and the an alarm may confidentially be issued to call personnel for assist as well. In addition, a signal may be transmitted via the signal line 156 to switch on the optical sensing apparatus 116, and images are produced by the optical sensing apparatus 116 and is transmitted to a predetermined object for recording, so as to record the event and rescue the man who is under threaten to open the door.

It should be noted that while in the embodiment the process apparatus 118 and the storage apparatus 120 are communicated via wireless communication 122, the process apparatus 118 and the storage apparatus 120 may communicate one the other via a physical wiring line like the signal line 154.

On the other hand, the signal lines 152, 154, 156, and 160 may be replaced by wireless means. Additionally, the storage apparatus 120 may be disposed in the housing 100. In other words, the connecting method of the every elements and the position thereof will not affect the normal functions of the disclosure, and both wired or wireless connection method are interpreted as a kind of electrical coupling method.

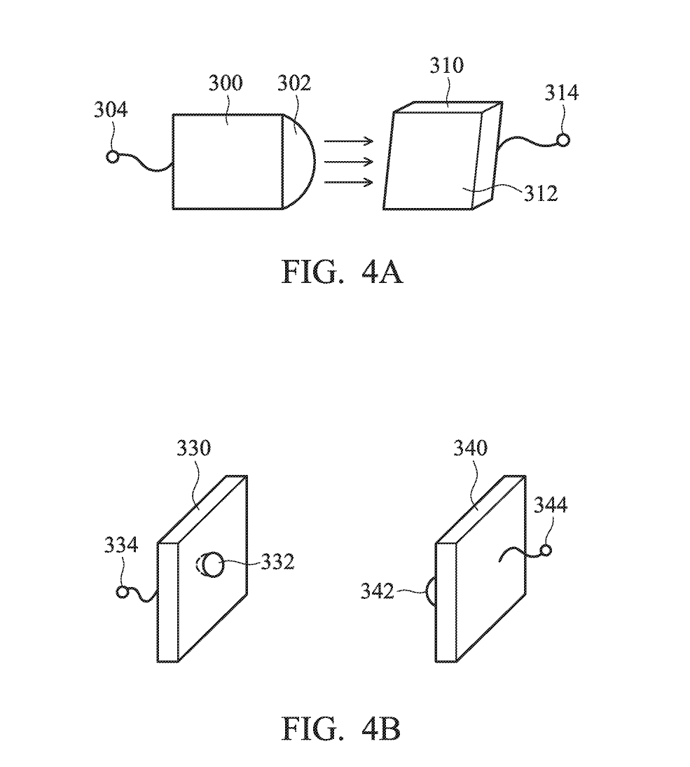

To prolong the operation time for the door lock system 10, the disclosure provides an electric charging unit 140 to supply electric power for the door lock system 10. As shown in FIG. 1, the electric charging unit 140 includes a power supply apparatus 142 and a power storage apparatus 144, wherein the power supply apparatus 142 may be an electric power supply structure that utilizes any way to able the circuit storage apparatus 144 to access electric power, and the power storage apparatus 144 is able to store electric power and supply the electric power to the lock member 130 and each elements in the lock control unit via the electric power supply line 146. The power supply apparatus 142 and the power storage apparatus 144 may respectively disposed in the door frame and the door panel. For example, as shown in FIG. 4A, the power supply apparatus 300 is a light emission apparatus, and one end thereof is a light source 302 that uses electric power to emit light, and the other end thereof is connect to the power source 304 such as commercial power; one end of the power storage apparatus 310 is a photoelectric receiving switching apparatus 312 which faces the light source 302 to receive the light from the light emission apparatus 300, and the other end there of is connected to the power supply line 314 to supply power to the door lock system. In another example, as shown in FIG. 4B, a recess 332 is formed on the power supply apparatus 330, and there is one end being able to be connected to power source 344 such as commercial power; a protrusion 342 that is compatible to the recess is formed on the power storage apparatus 340, and there is one end being connected to the electric power transmission line 344 for supplying electric power to the door lock system. The protrusion 342 may be connected to the recess 332 so as to form a successive conductor by stably overlapping the power supply apparatus 330 and the power storage apparatus 340 and facilitate transmission of the electric power from the power supply apparatus 330 to the power storage apparatus 340. In one embodiment, magnets are disposed on each of the power supply apparatus 330 and the power storage apparatus 340 for facilitating overlapping and fixing. It should be noted that except for the electric charging unit shown in the above-mentioned embodiments, other mechanism (such as Electromagnetic induction discharging, etc.) which is able to transmit electric power can be used in the system of the disclosure. The operation of the disclosure is not affected by the physical mechanism of the electric charging unit.

Furthermore, in order to decrease the consumption of the electric power, the door lock system 10 further includes an optical sensing apparatus 116. The optical sensing apparatus 116 may simply detects the light shadow nearby, and generates a pre-set signal as detecting object approaching; alternatively, the optical sensing apparatus 116 may be a camera apparatus and determines if an object approaches by capturing images so as to generates the pre-set signal as detecting object approaching. The pre-set signal is transmitted to the process apparatus 118 via the signal transmission line 156. In one embodiment, the door lock system 10 is controlled in a standby state if the process apparatus 118 does receive the pre-set signal for saving electric power; after receiving the pre-set signal, the process apparatus 118 enables the door lock system 10 to a complete operation mode so as to receive and process the key information. In another embodiment, the door lock system 10 is always operated normally, but the process apparatus 118 will not process the key information until receiving the pre-set signal, in the case of without receiving the pre-set signal it stops processing the key information for preventing error operation due to the detection of mistakenly touching.

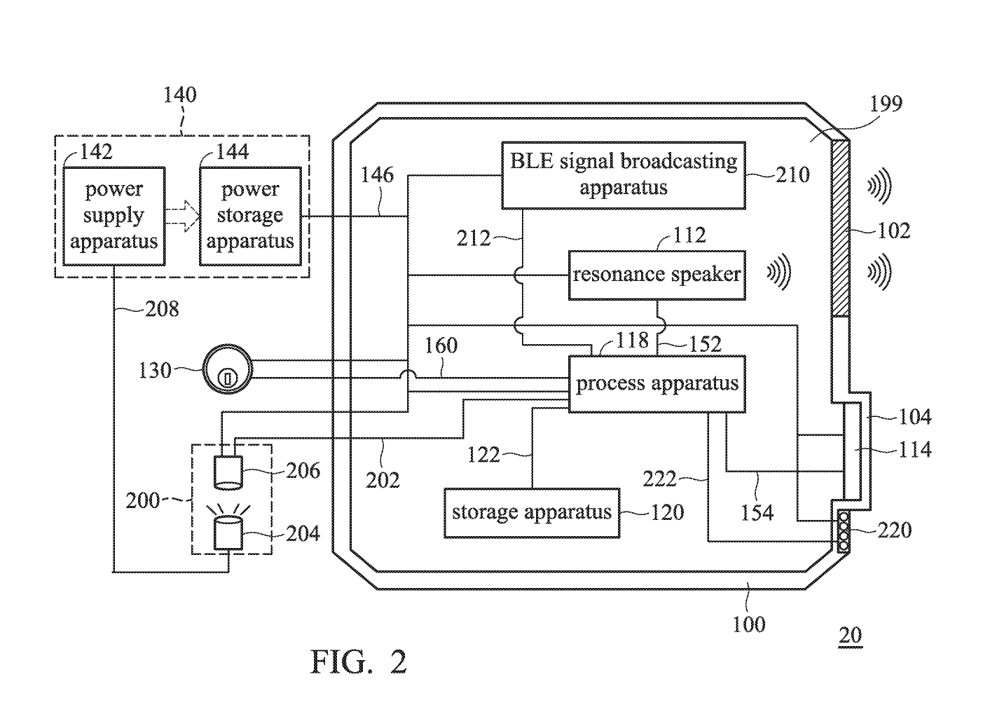

FIG. 2 shows a structural schematic view of another smart door lock system, in accordance with the second embodiment of the disclosure. In the embodiment, in addition to the door lock system 10 shown in FIG. 1, the door lock system 20 further includes a door position sensing unit 200, a BLE signal broadcasting apparatus 210. In order to enable these elements to be normally operated, electric power is supplied to these elements via the electric power supply line 146, and the central process apparatus 118 is connected to each of these elements to transmitted necessary signals via the signal transmission lines 202, 212 and 222.

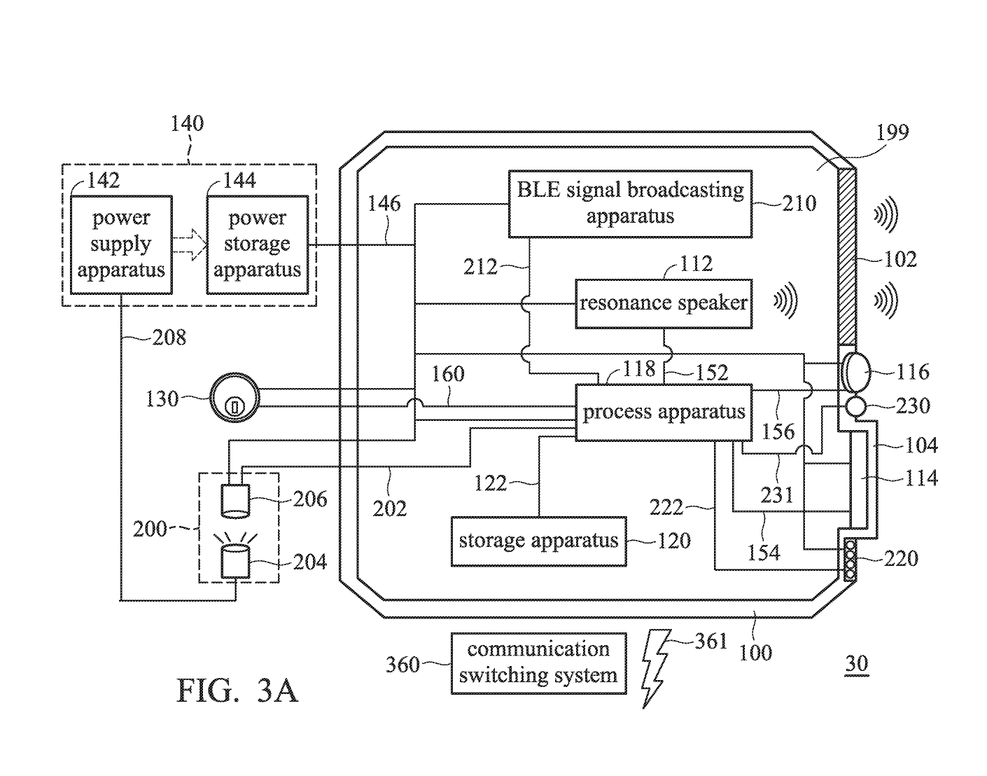

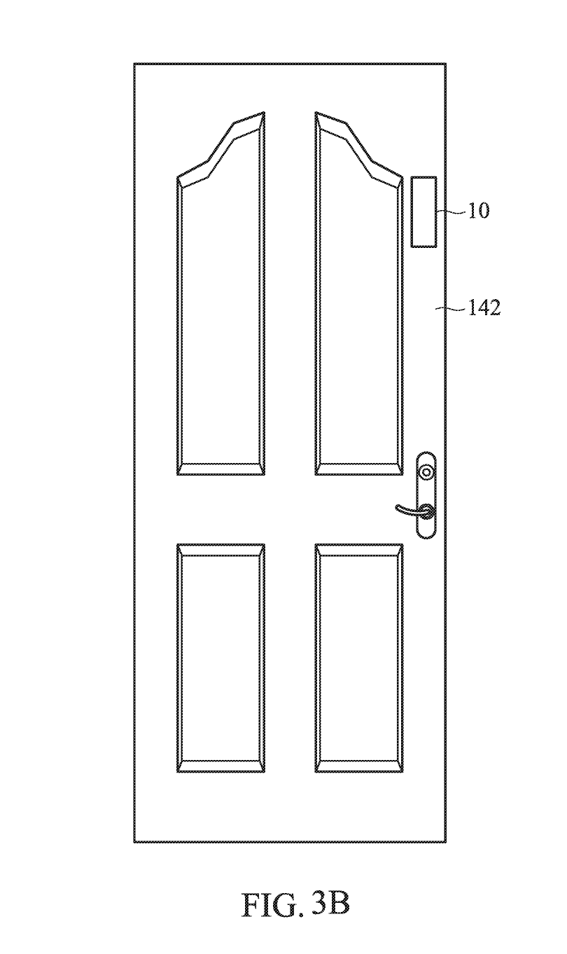

As shown in figure, in the embodiment, the door position sensing unit 200 includes two infrared ray transmitters/receivers 204 and 206 respectively disposed in the door frame and the door panel. The infrared ray transmitter/receiver 204 is used to transmit infrared ray, and the infrared ray transmitter/receiver 206 is used to transmit infrared ray to the infrared ray transmitter/receiver 204 after receiving the infrared ray emitted by the infrared ray transmitter/receiver 204. Once receiving the infrared ray emitted by the infrared ray transmitter/receiver 206 (i.e., the two infrared ray transmitters/receivers 204 and 206 aligns one the other as the door panel is closed relative to the door frame), the infrared ray transmitter/receiver 204 issues a switch on signal to the power supply apparatus 142 via the signal transmission line 208 to enable the power supply apparatus 142 to supply power to the power storage apparatus 144, and the power storage apparatus is charged with electric power, as show in FIG. 3A and 3B, for example. Additionally, before the receiving of the infrared ray transmitted by the infrared ray transmitter/receiver 204 (i.e., the two infrared ray transmitters/receivers 204 and 206 do not align one the other as the door panel is opened relative to the door frame), the infrared ray transmitter/receiver 206 can also transmits a standby signal to the process apparatus 118 via the signal transmission line 202 to enable the process apparatus 118 to adjust the door lock system 20 to a standby state, so as to save electric power.

Moreover, in the embodiment, the BLE signal broadcasting apparatus 210 is able to continuously or periodically broadcast a set of BLE signals (such as iBeacon techniques), and the set of BLE signals carrying ID number which represents the door lock system 20. Once an apparatus (such as a smart phone), which is able to receive BLE signal, appears in the vicinity of the door lock system 20, the device can perform a preset process according to the ID number of the door lock system 20. The preset process includes, for example, transmit a set of information to a particular server to record the time of the access or transmit a set of password to the process apparatus 118, and the process apparatus 118 determines whether the lock member 130 should be unlocked if the password and key information meets a particular serial number so as to strengthen the management in personnel access.

Furthermore, in the embodiment, the sonic wave receiving apparatus 220 can be used to receive an external acoustic signals and generate a set of identification information in accordance with the received acoustic signals, and the identification information is transmits to the process apparatus 118 via the signal transmission line 222. In this case, in addition to analyzing the relationship between the key information and the verification information which mentioned above, the process apparatus 118 also determines whether the lock member 130 should be unlocked according to the received identification information so as to strengthen the management in personnel access.

The contents, such as the information transmitted to the served from the device which is able to receive BLE signal, the keywords transmitted to the process apparatus 118, or the message embedded in the sonic wave signal, can be stored in the device held by the user by any method. For example, it can be stored in either APP or QR code of the smartphone. Additionally, these content may have validity duration, once the duration is passed, the contents are not admitted by the door lock system. As a result, a management for the permission in particular duration can be realized.

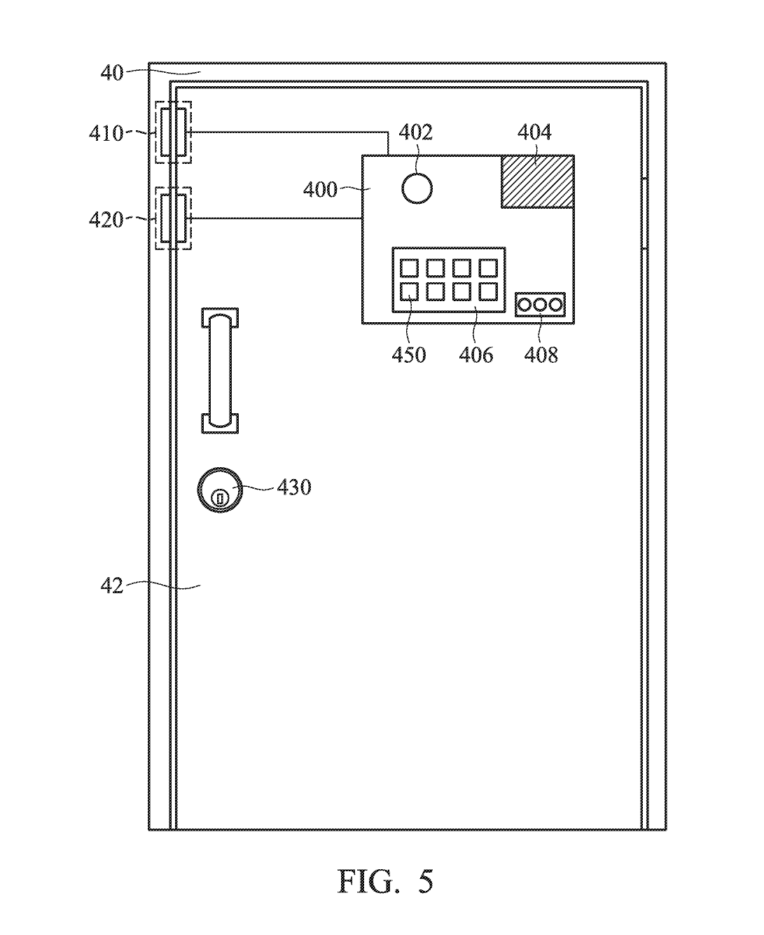

FIG. 5 shows a schematic view of a door lock system disposed on a door, in accordance with the second embodiment of the disclosure. In the embodiment, the door lock system is adapted for controlling the door frame 40 and the door panel 42 compatible to the door frame. In FIG. 5, only elements that can be shown in front views are illustrated, other elements that are covered or can be disposed in other disposed are not illustrated.

As shown in the figure, the housing 400 is disposed on the door panel and includes an optical sensing apparatus 402, a first region 404 for generating sympathetic vibration, a second region 406 having a number of keys 450, and an optical sensing apparatus 408. Additionally, the lock member 430 is disposed in the door panel 42; the first portion of the power supply apparatus 410 (such as the power supply apparatus) is disposed on the door frame 40 and separated from the door panel, and the second portion of the power supply apparatus 410 (such as the power storage apparatus) is disposed on a position of the door panel 42 that corresponds to the first portion of the power supply apparatus 410; the first portion of the door position sensing unit 420 (such as the infrared ray transmitter/receiver 204 shown in FIG. 2) is disposed on the door frame 40 and is separated from the door panel, and the second portion (such as the infrared ray transmitter/receiver 206 shown in FIG. 2) is disposed on a position of the door panel 42 that corresponds to the first portion of the door position sensing unit 420.

Embodiments of the door lock system shown in FIGS. 1-4 facilitate a simple access management and have capability of warming hostage situation. Additionally, with the password, Bluetooth apparatus, sonic wave producer which differ from man to man, an access management function or punching management function can be realized.

### Third Embodiment

FIG. 3A shows a circuit block diagram of another smart door system, in accordance with a third embodiment of the disclosure. In the embodiment, in addition to the door lock system 20 shown in FIG. 2, the door lock system 30 further includes an optical camera apparatus 116, a microphone 230 and a communication switching system 360. In order to enable these elements to be normally operated, electric power is supplied to these elements via the electric power supply line 146, and the central process apparatus 118 is connected to the optical camera apparatus 116 via signal line 156 and connected to the microphone 230 via signal line 231.

The optical camera apparatus can capture the exterior image or video and send to the central process apparatus and to the storage apparatus for recording whenever the optical sensing apparatus 220 detect a moving object coming approach to it.

In an operation of doorbell ringing, the key apparatus 114 provide a mean to signal the central process apparatus to notify the mobile apparatus APP a doorbell is pressed. The central process apparatus will process the captured exterior image or video by optical camera apparatus and the exterior sound capture by microphone 230 and send to the mobile apparatus APP by means of digital signal transmitted by wireless or a signal wire.

The connection between the central process apparatus 118 and the communication switching apparatus 360 can be wireless or wire signal line. The communication switching system provides a mean of intranet and internet connection for the system 30 to a mobile apparatus APP.

FIG. 3B shows a schematic view of a smart door system disposed on a door 142, in accordance with the third embodiment of the disclosure. In the embodiment, the smart door system is adapted for controlling the door frame 40 and the door panel 42 compatible to the door frame in FIG. 4. In FIG. 3B, only the front views are illustrated, other elements that are covered or can be disposed in other disposed are not illustrated.

### Fourth Embodiment

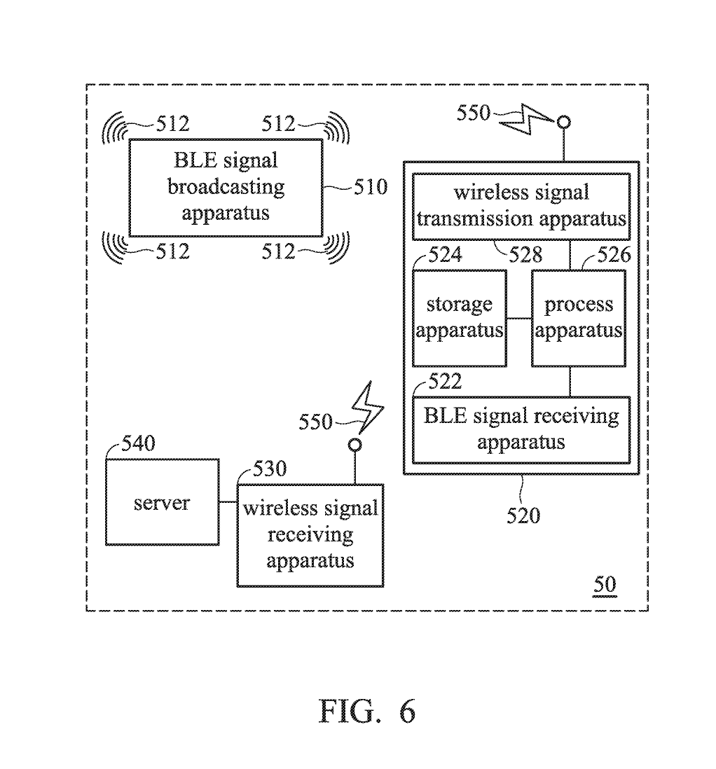

FIG. 6 shows a circuit block diagram of an identification system, in accordance with a fourth embodiment of the disclosure. In the embodiment, the identification system 50 includes a BLE signal broadcasting apparatus 510, a signal processing apparatus 520, a wireless signal receiving apparatus 530, and a server 540. The BLE signal broadcasting apparatus 510 is used to broadcast BLE signal 512, and the signal processing apparatus 520 (such as smart phone) is used to receive BLE signal 512 and transmit identification information corresponding to the BLE signal 512. After the received by the wireless signal receiving apparatus 530, the identification information is transmitted to the server 540. A set of verification information is stored in the server 540, and the verification information is matched with the identification information by the server 540 so as to determine the identification of the signal processing apparatus 520.

Specifically, the BLE signal 512 broadcasted from the BLE signal broadcasting apparatus 510 may include a specific ID number, for facilitating the determination of the source of the BLE signal 512 by the apparatus which receives the BLE signal 512. After the receiving of the BLE signal 512, the BLE signal receiving apparatus 520 (such as smart phone) transmits the contents of the BLE signal 512 to the process apparatus 526. The process apparatus 526 is electrically coupled to the BLE signal receiving apparatus 522, the storage apparatus 524, and the wireless signal transmission apparatus 528, and the BLE signal receiving apparatus 520 receives the BLE signal 512 and obtain the code therein, and a corresponding identification information is obtained from the storage apparatus 524 according to the code, and the identification information is transmitted to the wireless signal transmission apparatus 528.

After obtaining the identification information, the wireless signal transmission apparatus 528 transmits the identification information to the wireless signal receiving apparatus 530 by wireless communication 550.

To meet confidentiality requirements, the wireless communication 550 is better to be enciphered and is transmitted one by one, and therefore the wireless signal transmission apparatus 528 may be a Wireless LAN signal producing apparatus, and the wireless communication 550 is a transmission means of wireless area network communication protocol. Alternatively, based on consideration of ease of use, the wireless communication 550 may use sonic wave as a carrier, and the wireless signal transmission apparatus may be sonic wave generating apparatus, such as a speaker of the smart phone. When the signal processing apparatus 520 is a smart phone, the two kinds of wireless communication means are respectively realized by the built-in wireless network processor and speaker.

After receiving the identification information which is transmitted by wireless communication 550, the wireless signal receiving apparatus 530 transmits the received identification information to the server 540 coupled to the wireless signal receiving apparatus 530. The server 540 outputs the stored verification information and matches with the verification information and the identification information. The verification information stored in the server 540 may include one or more users and the corresponding numbers of user data. After the comparison process, if the received identification information is identify with one of the user data, the access time is recorded, and the access record of the user is updated so as to ensure the personnel individual data and the number of people staying in the control zone. On the contrary, after the comparison process, if the received identification information is not identified with any one of the user data, an alarm is issued. Moreover, when the identification system 50 is connected to the lock member mentioned in the first embodiment, the identification system 50 determines whether the lock member should be unlocked according to the relationship between the identification information and the verification information.

The techniques of the embodiment can be applied in any situation which requires an identity determination, especially for the access management in the factory having a mess of people. With capability of automatically determining identity, the identification system can not only realize automatic punch function so as to relieve congestion crowd, but also realize a regional control, so as to prevent the personnel responsible for different works from mistakenly entering a wrong working area and avoid danger.

### Fifth embodiment

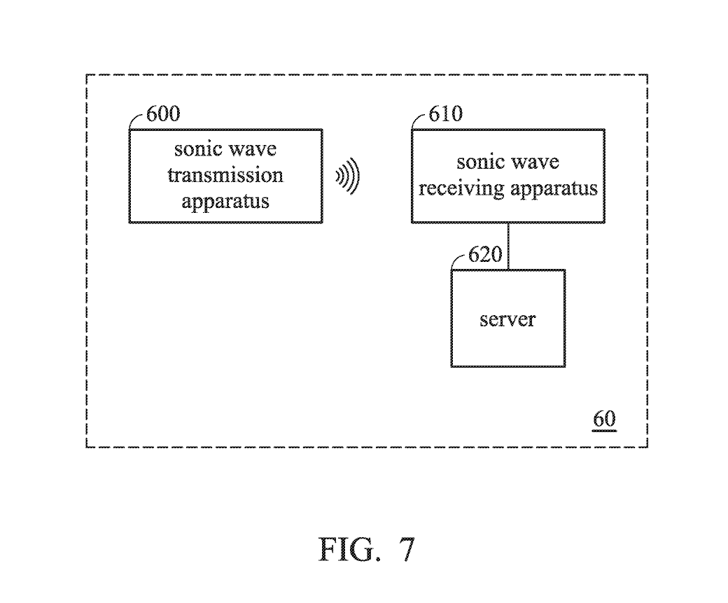

FIG. 7 shows a circuit block diagram of an identification system, in accordance with a third embodiment of the disclosure. In the embodiment, the identification system 60 includes a sonic wave transmission apparatus 600, a sonic wave receiving apparatus 610, and a server 620. The sonic wave transmission apparatus 600 is able to produces a sonic wave signal and transmits an identification information by the sonic wave signal; sonic wave receiving apparatus 610 is able to receive the sonic wave signal form the sonic wave transmission apparatus 600 and obtains the identification information embedded in the sonic wave signal; the server 620 is electrically connected to the sonic wave receiving apparatus 610 and obtains the identification information from the sonic wave receiving apparatus 610 to make comparison between the obtained identification information and the verification information stored in the server 620, and the identity of the sonic wave transmission apparatus 600 or the identification information is determined by the relationship between the identification information and verification information.

The operation process of the identification system 60 is elaborated below. To decrease the cost of the hardware of the identification system 60, the sonic wave transmission apparatus 600 may be a speaker of a smart phone, and the identification information embedded in the sonic waves utilizes sounds as a wireless communication technique which is a medium carrying information, such as sonic waves embedded information transmission protocol of SonarCast. This wireless communication technique encodes the information to be transmitted and packages in voice frequency (such as the frequency that can be hear by human being or frequency that cannot be hear by human being) and broad the encoded voice via the speaker.

Take an audio file used in the playing of the SonarCast, the audio file may include a header and a content. The content of the audio file can be filled up the identification information to be transmitted, such as user code, the current time of the sonic wave transmission apparatus 600, the private keywords of the user, etc. After particular encoding process of the identification information, encoded voice can be played by the sonic wave transmission apparatus 600. In order to make the identification system 60 operate functionally, it is better to approach the sonic wave transmission apparatus 600 to the sonic wave receiving apparatus 610 or to make the sonic wave signal played by the sonic wave transmission apparatus 600 can be directly received by the sonic wave receiving apparatus 610 rather than being received by the sonic wave receiving apparatus 610 after the reflection of another object.

The identification information embedded in the sonic wave signal is obtained by the sonic wave receiving apparatus 610 and transmitted to the server 620. The server 620 outputs the stored verification information and make a comparison between verification information and the identification information. The verification information stored in the server 620 may include one or more users and the corresponding numbers of user data. After the comparison process performed by the server 620, if the received identification information is identify with one of the user data, the entrance/leaving time of the user is recorded, and the access record of the user is updated so as to ensure the personnel individual data and the number of people staying in the control zone. On the contrary, after the comparison process performed by the server 620, if the received identification information is not identified with any one of the user data, an alarm may be issued. Moreover, when the identification system 50 is connected to the lock member mentioned in the first embodiment, the identification system 60 determines whether the lock member should be unlocked according to the relationship between the identification information and the verification information.

Furthermore, since the current time of the sonic wave transmission apparatus 600 is embedded in the sonic wave signal, even the sonic wave signal from the sonic wave transmission apparatus 600 is secretly recorded by another person, the sonic wave signal cannot be read by the identification system 60 due to difference between the stored time and the used time.

The techniques of the embodiments can be applied in any application that requires the determination of the identity, and the user can realized the operation by the use of a smart phone and downloading an APP that can generates sonic wave signal. Therefore, the cost of the hardware is decreased, and the risk to be secretly recorded can be prevented.

In summary, the disclosure provides a door lock system or an identification system to effectively facilitate multi-person access control management or identity determination.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. A smart door system comprising a door, a door lock unit, a doorbell system adapted to control the door and a communication switching system, wherein the door comprises a door frame and a door panel compatible to the door frame, characterized in that the doorbell system comprises:
a lock unit, disposed in the door frame or the door panel, wherein the lock member comprises an electrical lock disengaging driving apparatus and an electrical lock position sensing apparatus, and the electrical lock releasing member is connected to the doorbell system by wired or wireless means;
a mobile apparatus APP, when the mobile apparatus APP receives a BLE signal from the BLE signal broadcasting apparatus, the mobile apparatus APP wirelessly transmits the a corresponding identification information to a wireless signal receiving apparatus, when the key of the doorbell is pressed or touched, the optical camera apparatus captures the image and record sound outside the door and wirelessly transmits the images and sound to the mobile apparatus APP via an identification process apparatus and a communication system, so as to facilitate the intercom function and watch the video outside the door simultaneously,
wherein the doorbell system comprising:
a housing fixed on the door panel or the door frame, wherein a space is defined in the inner side of the housing;
a resonance speaker disposed in the space or independently disposed outside the space via a connection line, wherein a sympathetic vibration occurs in a first region of the housing as the speaker producing vibration, or a digital message or alarm sounds is sent out via creating contact between the resonance speaker and the door panel, the door frame or other elements that can generate sympathetic vibration
a microphone recording sound outside the door;
a key apparatus disposed at a second region of the housing. The key apparatus provides a number of the keys and generates key information in response to the order in which the keys are pressed, wherein one of the keys is a doorbell key;
a storage apparatus storing a verification information and image or video the optical camera apparatus produced;
an optical sensing apparatus detecting moving object near the door and generates a pre-set signal as objects approaching so as to switch on the identification process apparatus and the optical camera apparatus;
an optical camera apparatus capturing image or picture code outside the door, wherein the message of the picture code is analyzed by the identification process apparatus, stored in the storage apparatus in a picture or video format via the identification process apparatus, or wirelessly transmitted to the mobile apparatus APP; and
an identification process apparatus electrically coupled to the resonance speaker, the key apparatus, the storage apparatus, the optical sensing apparatus, the optical camera apparatus, and the microphone;
wherein the identification process apparatus includes a BLE signal broadcasting apparatus, a wireless signal receiving apparatus, and a process apparatus,
when the mobile apparatus APP wirelessly transmits the corresponding identification information to the wireless signal receiving apparatus, the process apparatus makes a comparison between the identification information obtained from the wireless signal receiving apparatus and the verification information stored in the server, and determine the identification of the mobile apparatus APP according to the relationship between the identification information and the verification information, and receive key information from the key apparatus, and determine whether the lock member should be unlocked according to the relationship between the key information and the verification information after the receiving of the pre-set signal; additionally, via the optical camera apparatus reading the picture code and transmits to the identification process apparatus for decoding and identification, and compare the verification information stored in the storage apparatus after the receiving of the pre-set signal, and determine whether the lock member should be unlocked according to the relationship between the identification information and the verification information;
an electric charging unit including a power supply apparatus and a power storage apparatus, wherein the power supply apparatus is separated from the door panel and is able to enable the power storage apparatus to obtain the electric power, and the power storage apparatus is disposed on the door panel to store and supply electric power to the lock member and the lock control unit.
a communication switching system utilizes SIP (Session Initiation Protocol) and XMPP (Extensible Messaging and Presence Protocol) as the signaling and communication of the mobile apparatus APP and the doorbell system.

2. The smart door system as claimed in claim 1, characterized in that: the power supply apparatus is a light emission apparatus, and the power storage apparatus includes a photoelectric receiving switching apparatus to receive the light transmitted from the light emission apparatus.

3. The smart door system as claimed in claim 1, characterized in that: the power supply apparatus has a recess, and the power storage apparatus has a protrusion compatible to the recess, when the door is closed, the protrusion is connected to the recess, so as to perform electric power transmission.

4. The smart door system as claimed in claim 1, characterized in that: further comprising a door position sensing unit, when the door is closed, the door position sensing unit controls the power supply apparatus to enable the power storage apparatus to obtain the electric power.

5. The smart door system as claimed in claim 1, characterized in that: further comprising an optical sensing apparatus to issue a pre-set signal and an optical camera apparatus to capture a picture code for the identification system.

6. The smart door system as claimed in claim 1, characterized in that: further comprising a BLE signal broadcasting apparatus to broadcast a BLE signal.

7. The smart door system as claimed in claim 1, characterized in that: further comprising a wireless signal receiving apparatus to receive an identification information, wherein the wireless signal receiving apparatus is electrically coupled to the process apparatus, and in addition to analyzing the relationship between the key information and the verification information, the process apparatus also determines whether the lock member should be unlocked or an alarm should be issued according to the identification information.

8. The smart door system as claimed in claim 1, characterized in that: further comprising the communication switching system utilizes SIP (Session Initiation Protocol) and XMPP (Extensible Messaging and Presence Protocol) as the signaling and communication of the mobile apparatus APP and the doorbell system.
